(19) United States
(12) Patent Application Publication
(10) Pub. No.: US 2025/0154865 A1
(43) Pub. Date: May 15, 2025

(54) SYSTEM FOR PROBABILISTICLY DETERMINING SHALE SMEAR OCCURANCE FOR FAULT SEAL ANALYSIS

(71) Applicant: Landmark Graphics Corporation, Houston, TX (US)

(72) Inventors: Jean-Christophe Wrobel-Daveau, Abingdon (GB); Andrew Davies, Abingdon (GB); Graham Baines, Abingdon (GB)

(21) Appl. No.: 18/507,550

(22) Filed: Nov. 13, 2023

(51) Int. Cl. E21B 47/113

(52) U.S. Cl. CPC E21B 47/113; E21B 2200/20

(57) ABSTRACT

Some implementations include a method for detecting leaks across a geological fault. The method may include determining probabilities of smears and smear breaches along a fault plane of the geological fault; and determining, based on the probabilities, one or more leak points through which hydrocarbon fluid leaks from a subsurface reservoir.

### TECHNICAL FIELD

The disclosure generally relates to the field of hydrocarbon recovery, and more specifically to determining occurrence of shale smears for fault seal analysis.

### BACKGROUND

In subsurface exploration and production, fault seal analysis may be critical in understanding the sealing capacity across faults. Applications range across oil and gas, waste storage (e.g., CO₂, radioactive), and groundwater circulation (e.g., useable aquifers). In sedimentary sequences, methods like shale gouge ratio (SGR) or clay smear potential (CSP) may be used, which consider the fault properties as a continuum of smeared shale within the fault gouge. However, these methods may have uncertainties related to several factors including: 1) estimating the volume and plasticity of clays; 2) assuming that shales behave plastically without accounting for possible breaches of fault gouge; 3) calculating shale volumes on one side of the fault, typically the footwall, may lead to asymmetrical smearing; and 4) estimating gouge permeability may rely on uncertain parameters such as breakthrough pressure, fault gouge thickness, and cataclasis.

### BRIEF DESCRIPTION OF THE DRAWINGS

Implementations of the disclosure may be better understood by referencing the accompanying drawings.

FIG. 1 is a schematic cross-section of the subsurface illustrating geological conditions that may be detected by some implementations. It shows the application for the field of CCUS, with a CO₂ injector as an example, a similar figure could be drawn using a steam or water injector for enhanced oil recovery, or for gas and/or oil producers.

FIG. 2 is a set of diagrams illustrating how the Shale Gouge Ration (SGR) technique may estimate fault sealing potential.

FIG. 3 includes a flow diagram showing an overview of operations for probabilistically modeling presence of holes in a fault gouge.

FIG. 4 includes images illustrating a method for probabilistically modeling presence of holes in a fault gouge.

FIGS. 5 and 6 are flow diagrams illustrating operations for determining presence of smears and smear breaches along a fault.

FIG. 7 is a diagram showing a Gamma Ray signal converted into lithologies.

FIG. 8 is a diagram showing how some implementations may place smears along the fault plane using different placement methods (i.e., FASM: Footwall attached method, HASM: Hangingwall attached method, MSS: Mid-point Split Smear, SSR: Random Split Smear, and RPS: Randomly Placed Smear)

FIG. 9 includes graphs showing smear placement for different placement methods (for one given fault displacement value, here 200 m).

FIG. 10 includes graphs showing cumulative occurrence of smear for given locations along a fault gouge based on different placement models (for one given fault displacement value, here 200 m).

FIG. 11 includes a graph showing likely presence of smear and shale juxtaposition.

FIG. 12 is a block diagram illustrating a computer system that may be utilized with some implementations.

FIG. 13 includes graphs showing results of 100 simulations using the Random Split Smear placement method (with one single displacement value).

FIG. 14 includes a diagram illustrating a probabilistic approach to determining smear likelihood and properties at one point on a fault for a two-layer case.

### DESCRIPTION OF IMPLEMENTATIONS

The description that follows may include example systems, methods, techniques, and program flows that embody implementations of the disclosure. However, this disclosure may be practiced without these specific details. For clarity, some well-known instruction instances, protocols, structures, and techniques may not be shown in detail.

### Overview

Faults may be complex and fault sealing capacity may be affected by the composition of the “country rock”, fault geometry, fault throw, mineralization and other factors. Therefore, assessing the possible likelihood, properties, and distribution of fault smear may be highly uncertain, and yet may play a key role in estimates of oil-in-place, hydrocarbon column height, and production forecasts, or any other possible applications of this invention such as but not limited to geological waste storage, or groundwater circulation.

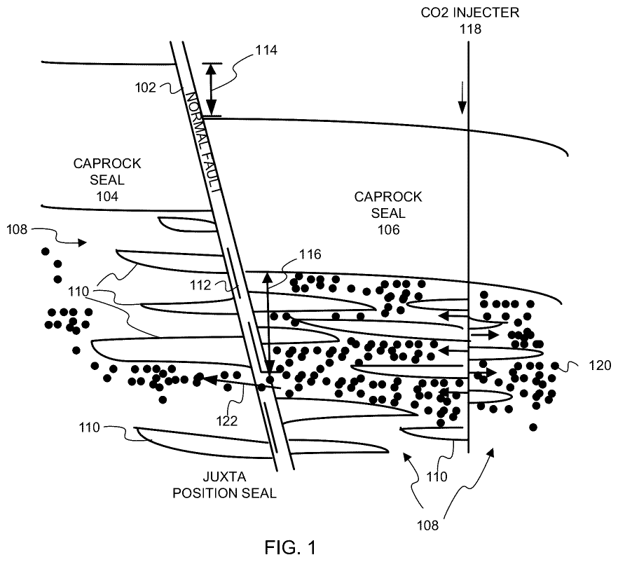

Some implementations include a system for determining fault sealing potential along a fault and detecting smears, leak points, and/or other geological conditions related to faults. FIG. 1 is a diagram illustrating geological conditions that relate some implementations. FIG. 1 shows a normal fault 102 running through a caprock seal 104 and 106, a reservoir sand 108 (shown as whitespace below the caprock seal 104 and 106), and impermeable shale layers (or “juxtaposition seals”) 110. A fault throw is indicated by arrow 114. The fault 102 may include clay smears 112. Carbon dioxide may be injected into the space below the caprock seal 106 via a carbon dioxide injector 118. Carbon dioxide plume 120 may exit the carbon dioxide injector 118 leftward and rightward into the reservoir sand 108 underneath the caprock seal 106. The carbon dioxide column height is indicated by arrow 116. The carbon dioxide plume 120 may move through the reservoir sand 108 to the fault 102. However, some portions of the fault 102 may not be permeable to the carbon dioxide plumes 120. Hence, the fault 102 may seal the carbon dioxide plumes 120 in the reservoir sand 108 to the right of the fault 102 (as shown in FIG. 1). More specifically, the clay smears 112 may prevent carbon dioxide plumes 120 from passing though the fault 102. Additionally, the juxtaposition seals 110 on both sides of the fault 102 also may seal the fault 102 by preventing the carbon dioxide plumes 120 from passing though the fault 102. However, one or more portions of the fault 102 may be permeable to the carbon dioxide plumes 120 and/or other fluids. The leak point 122 shows a point at which the carbon dioxide plumes 120 may pass through the fault 102, due to the absence of juxtaposition seal 110 and/or clay smear 112.

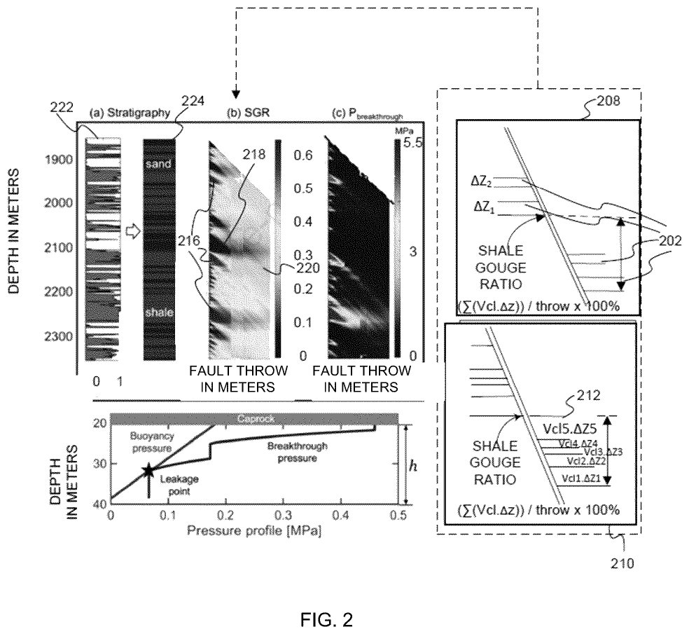

FIG. 2 is a set of diagrams illustrating how the Shale Gouge Ration (SGR) technique may estimate fault sealing potential. SGR is a traditional technique that uses layer thickness, fault throw, and other values to estimate sealing potential along a fault. SGR may be based on Shale volume (Vsh) 222 derived from geological data such as but not limited to Gamma Ray signals that are processed to determine sand and shale regions 224 in a volume. SGR also may be based on computations involving layer thicknesses 202 along a fault 204, fault throw 206, or VClay (volume of clay) and individual layer's thickness (Δz) for given layers 212 (see computations noted in blocks 208 and 210 of FIG. 2). SGR estimation (with 2016 referring to areas of high SGR values, 218 to areas of low SGR values and 220 to areas of medium SGR values) may be used to calculate specific physical conditions such as breakthrough pressure that may be compared to the buoyancy pressure of a given fluid in the specific subsurface condition to determine whether the fault may be sealing or leaking given this set of pressure difference.

Some implementations include a new method that may completely replace SGR or may work with SGR. When replacing SGR, the new method may determine presence and location of holes in a fault gouge and presume the fault is leaking through the holes. When working with SGR, the new method may augment an SGR result with a probability of holes in the fault gauge. Hence, the new method may show that SGR is too optimistic/pessimistic about fault seals. Some implementations also may use the concept of juxtaposition to probabilistically model presence of holes in the fault gouge.

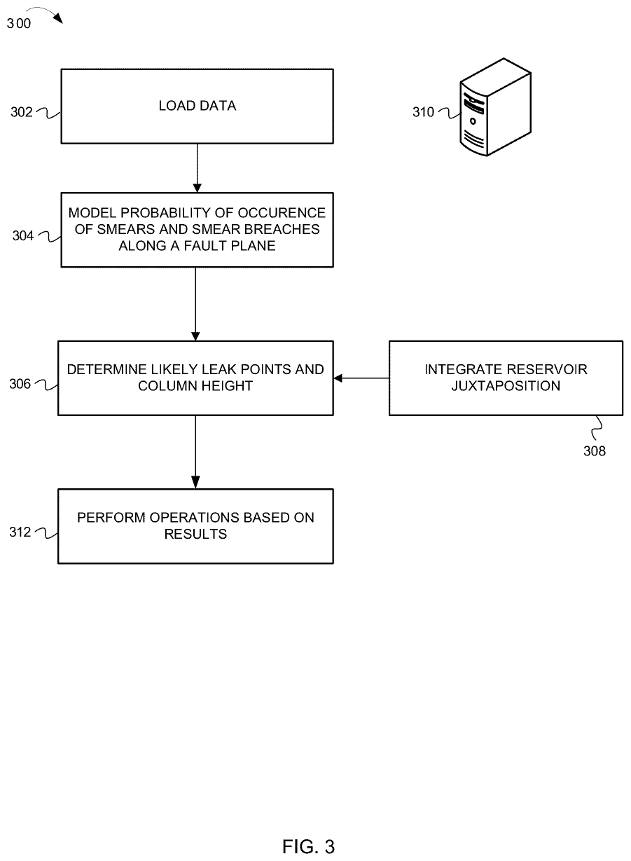

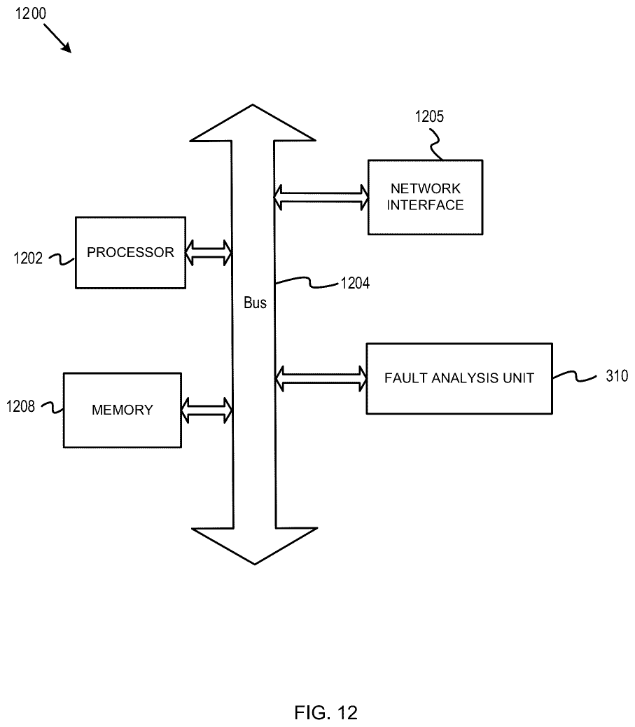

FIG. 3 includes a flow diagram showing an overview of operations for probabilistically modeling presence of holes in a fault gouge. In some implementations, operations may be performed by a fault analysis unit 310 (see also discussion of FIG. 12). The flow 300 begins at block 302, where the fault analysis unit 310 may load data such as Gamma Ray signal data from a well. The Gamma Ray signal data may have been processed to indicate lithologies including sand, shale, and others.

At block 304, the fault analysis unit 310 may model probability of occurrence of smears and smear breaches along a fault plane.

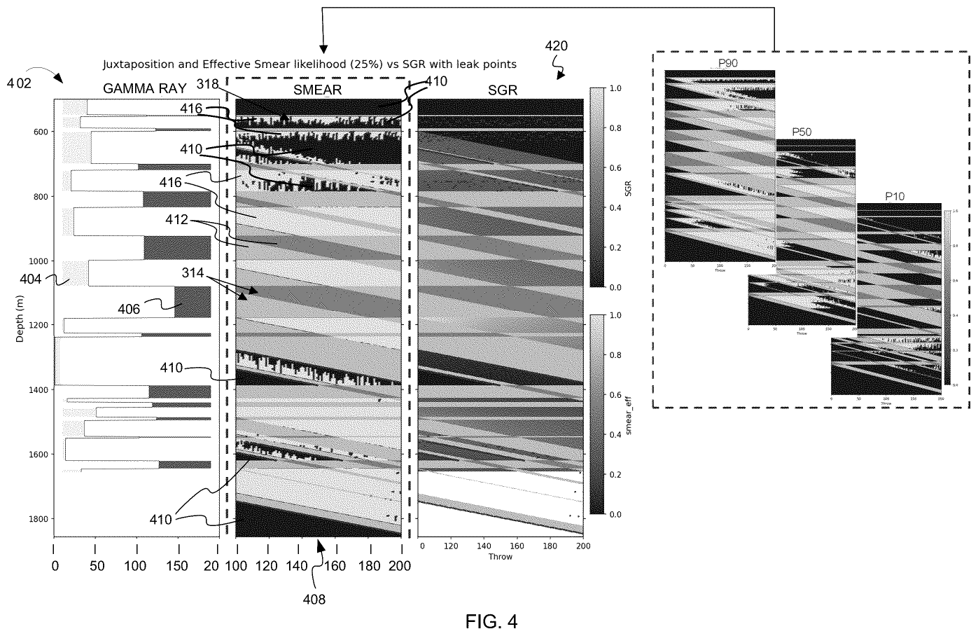

At block 306, the fault analysis unit 310 may determine likelihood of leak points and fluid column height. Leak points will be described in more detail with reference to FIG. 4. In some instances, the fault analysis unit 310 may integrate the concept of reservoir juxtaposition into the model (see block 308).

At block 312, various operations may be performed based on the results of the model. For example, based on a better understanding of the probability of holes along a fault plane, operators may make business decisions, perform subsurface operations (drilling, lift, tooling, etc.), and perform other operations.

FIG. 4 includes images showing models that predict locations of holes in a fault gouge in relation to fault offset. Some implementations may interpret a Gamma Ray (or shale volume derived from Gamma Ray) signal 402 to indicate lithologies including sand 404 and shale 406. Some implementations may produce a model 408 showing the layers near a fault. The model 408 is a triangular diagram representation showing in y-axis the depth of rock layers in contact on either side of the fault (i.e., footwall (fixed) and hangingwall (displaced, dropped down)) displaced along the throw values in x-axis. The model 408 may indicate shale 412 (with two types of shading), smears 416, breaches 410, along model fault throw values ranging here as an example from 0 meters to 200 meters. If one layer of shale 412 or two layers of shale 412 are juxtaposed across the fault, the model may consider having a sealing effect across the fault.

The model 408 also may indicate smears 416, leak points 318, and breaches 410. The smears 416 may contain smeared clays. The smears 416 may form seals across the fault. However, the smears 416 may include leak points 418 through which fluids pass across the fault. The breaches 410 are regions of reservoir-to-reservoir contact.

In some implementations, the model 408 is augmented with a probabilistic risk assessment that assigns a statistical p-value 430 to indicate likelihood of the smears 416. In FIG. 4, results from the SGR technique 420 appear next to the model 408.

There are drawbacks to SGR and other traditional techniques for estimating fault scaling potential. For example, if there are holes in the fault gouge, SGR may not accurately estimate fault sealing potential. Additionally, in the case of SGR, the calculation of flow across the fault (in the case of a leaking fault) is a function of SGR and other parameters. The flow thus relies on the calculation of a permeability value across a volume of rock with modified properties compared to the reservoir rocks on either side of the fault. These parameters may include but are not limited to parameters such as fault gouge thickness or cataclasis content. These parameters are themselves associated to uncertainties and challenges to estimate. For instance, the thickness of fault gouge is difficult to estimate as it has been demonstrated to not correlate to fault length or displacement.

Some implementations overcome the above-noted drawbacks by utilizing a probabilistic stochastic method that considers discrete occurrences of shale smears and smear breaches (tears) along a fault gouge. Some implementations integrate smear placement models to determine the likelihood of smear presence. Some implementations employ a classification method that includes probabilistic calculations for VClay (volume of clay), simulates various fault throw scenarios, randomizes a ductility parameter like the critical shale smear factor (SSFc), and performs stochastic simulations.

Some implementations may combine the probabilistic results of smear placement methods to determine likelihood of smear presence. By using variable thresholds, some implementations may establish alternate scenarios for the seal positions based on the fault displacement. When combined with a reservoir-seal juxtaposition approach, some implementations enable determination of leak point positions, volume containment capacities, and fluid flows across the fault. Additionally, some implementations may provide a risk and uncertainty assessment of smear breaches in the gouge, which can be used in conjunction with traditional SGR-based permeability calculations in three-dimensional static and dynamic models.

Some implementations may provide an alternative or complement to traditional approaches that are based on the calculation of a shale smear continuum (such as SGR-based methods) in the fault gouge. Some implementations may probabilistically interpret subsurface data (such as well data, seismic data, and/or other data) into lithologies, and defined sealing intervals such as shales. After defining a maximum displacement along a fault, each shale layer may be assigned a ductility parameter (ductility parameters may be randomized or not). This allows implementations to determine shale smear length for each increment of displacement along fault. Some implementations may perform stochastic simulations of the different (weighted) placement methods of smears and smear breaches in the gouge (geology-based) and combined those simulations to create a probabilistic assessment of the likely presence or absence of smears along the fault gouge. Some implementations may combine the smear likelihood with a reservoir juxtaposition approach (such as triangular diagram, Allan maps, or other suitable methods) to assess across-fault sealing potential. Some implementations may apply a risk threshold to estimate different levels of risk of smear presence along the fault. Some implementations may integrate the results to static and dynamic flow models to understand positions of leak points and height of fluid columns together with the associated risk on different scenarios and provide support for decision-making related to hydrocarbon exploration (such as subsurface operations) or other applications such as but not limited to geological waste storage of ground water circulation.

### Example Operations and Configurations

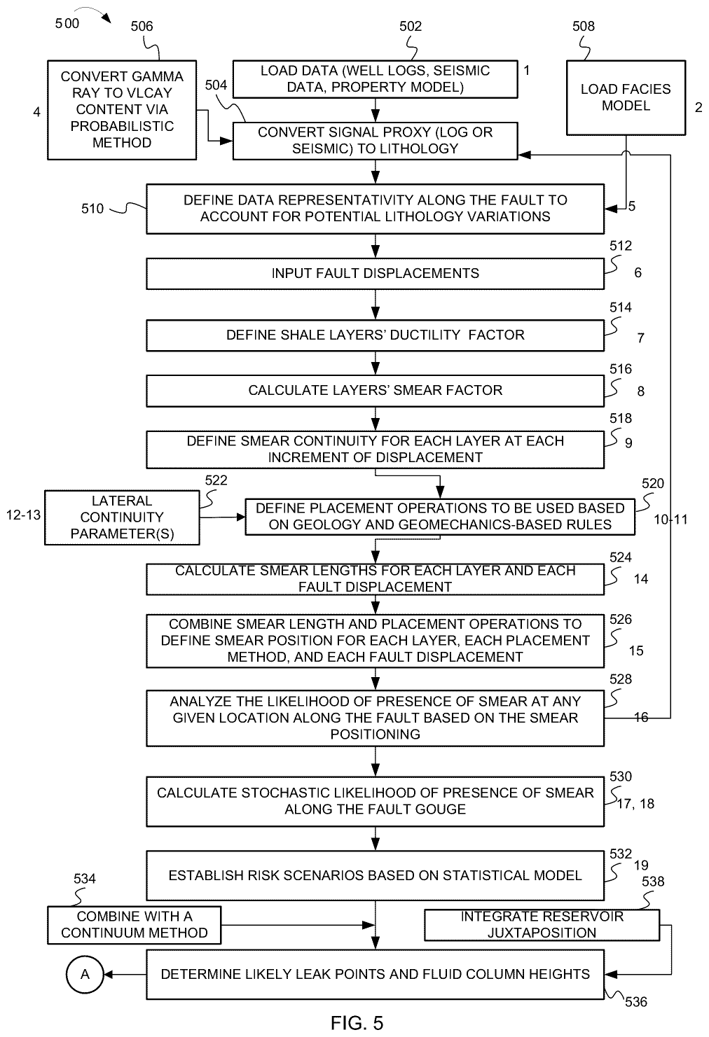

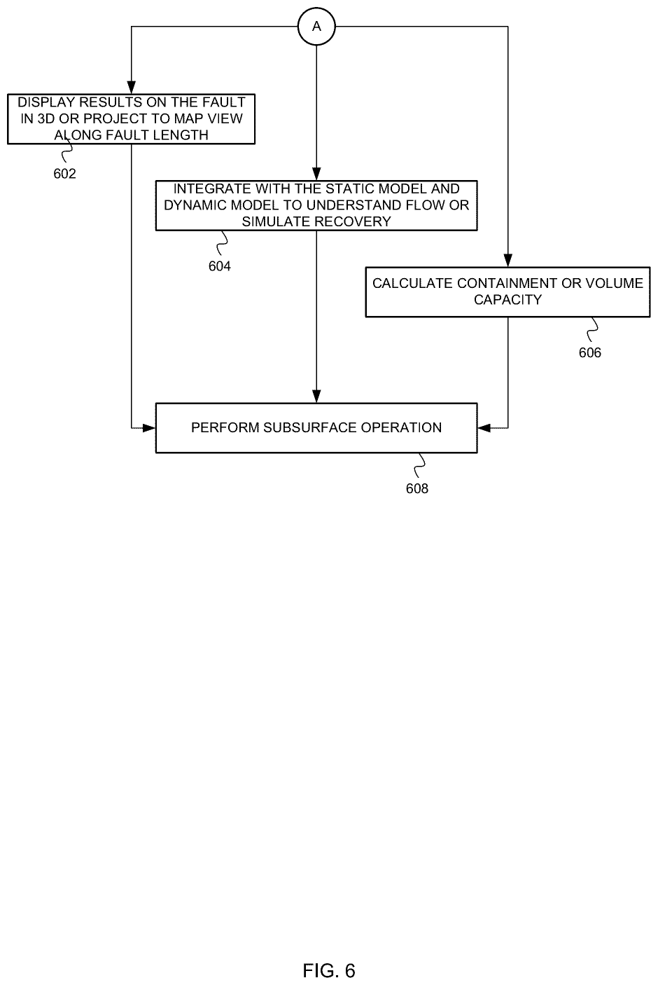

FIGS. 5 and 6 are flow diagrams illustrating operations for determining presence of smears and smear breaches along a fault. In FIG. 5, an operational flow 500 begins at block 502. Operations of the flow 500 may be performed by the fault analysis unit 310 or other suitable computerized components.

At block 502, the fault analysis unit 310 may load primary source data (such as well logs and/or seismic data) and/or property models that may be used in the flow 500. The data may include Gamma Ray signal data. The flow may continue at block 504.

Some implementations may loop through the operations at blocks 504-528 one or more times. Each iteration of the loop may create a distinct iteration of the model, where each iteration of model indicates smears, leak points, breaches, and/or any of the aspects described herein.

At block 504, the fault analysis unit 310 may convert the data (loaded at block 502) into rock facies and/or lithology models indicating shale, sandstone, etc. Converting the data into rock facies and/or lithology models may include the operations of block 506.

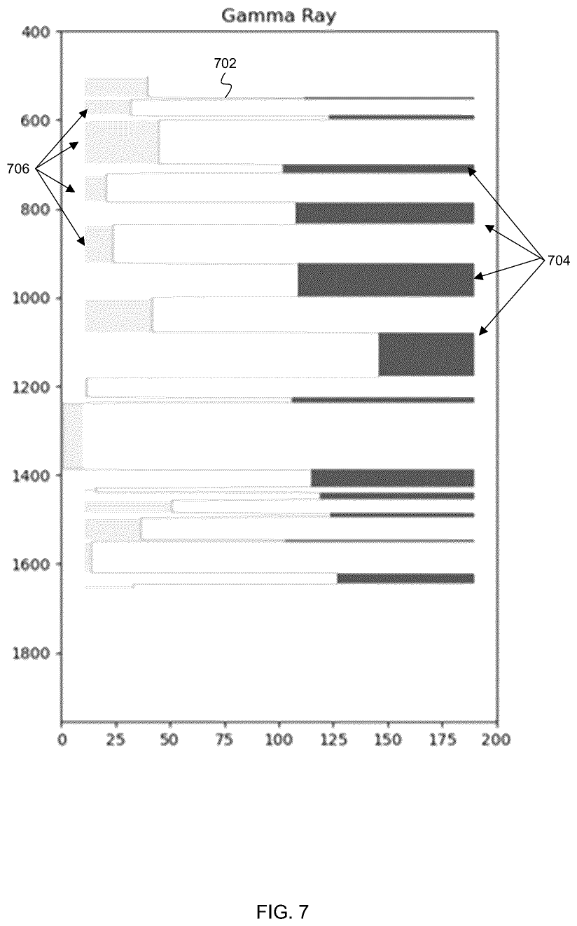

At block 506, the fault analysis unit 310 may determine shale content and distinguish shale layers from sandstone layers based on well log data (such as Gamma Ray signal data) or seismic data (such as the seismic inversion data). The fault analysis unit 310 may determine shale content and distinguish layers based on probabilistic techniques (such as a Linear Vsh IGR indicator, a Larionov model for old and young rocks, a Clavier model, a Stieber model) or different definitions of clean sand and clean shale (such as Gamma Ray_{clean sand}=30, 40, etc.). The fault analysis unit 310 may stochastically evaluate the lithology from well logs or seismic data and change the lithology at each iteration of the model. FIG. 7 is a diagram showing a Gamma Ray signal converted into lithologies. As shown in FIG. 7, the fault analysis unit 310 may convert a Gamma Ray signal 702 into discrete lithologies of shale 704 and sandstone 706 (and/or other lithologies).

As an alternative to performing blocks 502-506, the fault analysis unit 310 may load a facies model at block 508. The flow 500 may continue at block 510.

Some implementations may require information about the lithological properties on both sides of one or more faults. In some cases, the fault analysis unit 310 may use a representative well containing lithological information that may be offset at a distance from the fault. In other cases, the fault analysis unit 310 may use a 3D property model which captures lithology variability along the fault. This information about the lithological properties may be derived from geostatistical interpolation or seismic inversion for example. At block 510, the fault analysis unit 310 may define data representatively along the fault to account for potential lithology variations. In some implementations, the fault analysis unit 310 may define data representatively along the fault where one or multiple logs may be used to represent the lithology of the fault plane. This may account for potential lithological variations along the fault plane and allow for adjustment of the lithological column from an offset well to be projected and represented of the lithology of the fault. This may entail a thickness adjustment. The flow 500 may continue at block 512.

At block 512, the fault analysis unit 310 may determine fault displacements. Fault displacement may vary among the fault length and the fault profile, where the displacement varies from a node displacement to a maximum displacement (generally expressed in length units such as meters). The fault analysis unit 310 may perform operations to input a maximum fault displacement. The maximum fault displacement may be obtained from interpretation of real data or simulated based on a user-defined input and an associated uncertainty. Alternatively, the displacement, including the lithological/stratigraphic rock horizons where the displacement may be calculated in various locations (as considered representative) on the fault plane. Uncertainty on the fault's displacement may be associated to the direct length measurement for the measure of the throw and the measure of the fault's dip. The flow 500 may continue at block 514.

Shale ductility may impact the length of the clay smear and the occurrence of smear breaches along a fault plane displacing a shale layer. Shale ductility may vary as a function of the shale content, type of clay or confinement pressure at which the formation takes place. This may be poorly constrained by access to data for individual shale layers and may be generally constrained by analogs and empirical experimentations. At block 514, the fault analysis unit 310 may, for each shale layer, define a critical ductility factor such as Shale Smear factor-SSFc which may establish the extent (maximum value) of the layer's likely plastic behavior (before it reaches). This may be defined for known data (including uncertainty), randomized (i.e., changes at each model iteration), or simulated using given values (such as end-members) between empirically defined values and existing studies (analogous studies). The flow may continue at block 516.

At block 516, the fault analysis unit 310 may calculate smear factor for each shale layer. The fault analysis unit 310 may determine smear factor by calculating a Shale Smear Factor (SSF). The smear factor calculation may be based on a ratio between the fault's displacement and the layer's apparent thickness. SSF uncertainty may be associated with uncertainties on the displacement and on the layer's apparent thickness (including interpretation of the true stratigraphic thickness and the uncertainty of the layer's dip). The flow 500 may continue at block 518.

At block 518, the fault analysis unit 310 may define smear continuity for each layer and each increment of displacement. For each shale layer, the fault analysis unit 310 may define smear continuity by comparing SSF to SSFc to establish whether the smear is likely to be continuous or discontinuous. For example, if SSF<SSFc, the smear is continuous. Otherwise, the smear is discontinuous. SSFc may be randomized and thus may change for each layer and each model iteration. Hence, for a given displacement, layer, and iteration, a given smear continuity may change for each model iteration. The flow 500 may continue at block 520.

At block 520, the fault analysis unit 310 may define methods for placing smears along the fault plane. The placement methods may be based on geology and geomechanics-based rules. The placement methods may reflect any range of possibilities that may be encountered in nature. The placement methods may be based on geology, geomechanics rules, etc. The placement operations may include footwall-attached method (FASM), hangingwall-attached method (HASM), Mid-point Split Smear (MSS), Random Split Smear (SSR), Randomly Placed Smear (RPS), etc. In the case of discontinuous smear, the placement methods may consider the presence of one or more smear breaches (that is, holes in the fault gouge) in the smear for a given fault displacement. The smear placement methods may utilize one or more lateral smear continuity parameters 522 for randomized breaching (such as SSR) or placement (such as RPS). Lateral continuity of smear and smear breaches as a function of displacement may be considered using operations to constrain placement as a function of displacement based on the placement of adjacent smear position. This may allow constraining the shape of smear breaches and smears along fault plane and maintain lateral continuity that reflects mechanical behavior of the smear and smear breaches. The smear placement methods and lateral continuity parameters and relationships may be model based on geological rules including geostatistics, geo-mechanics, rheology geometrical relationships, and other suitable principles.

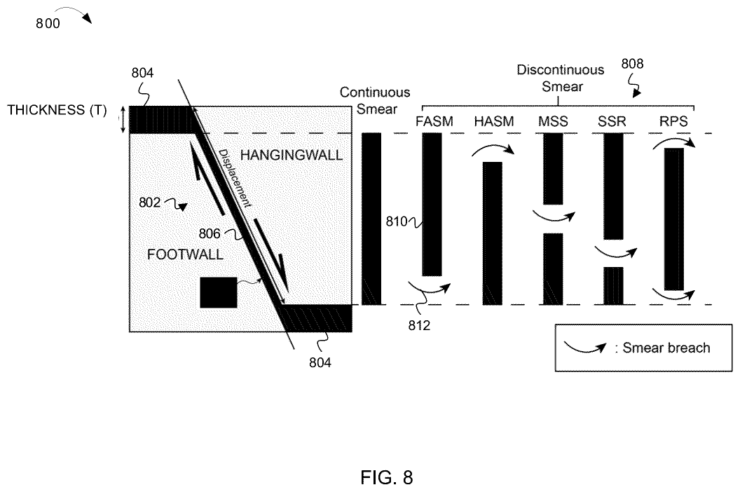

FIG. 8 is a diagram showing how some implementations may place smears along the fault plane. In FIG. 8, a diagram 800 shows a schematic dip-oriented cross-section representation of a normal fault 802 cutting through a shale layer 804 of thickness T and creating a fault gouge among the fault plane 806. In the case of discontinuous smear 808, several smear placement models (such as FASM, HASM, MSS, SSR, and RPS) have been schematically represented 810, each of which may represent a different geological scenario supported by geomechanically-based evidence, a specific likelihood of occurrence (weighting) and associated to different fluid flow and leakage implications represented by arrows 812. For example, FASM may place a smear 810 abutting the upper shale layer 804 (i.e., “footwall attached”) whereas HASM may place the smear 810 abutting the lower shale layer 804 (i.e., “hangingwall attached”). The arrows 812 represent smear breaches where fluids may leak. The flow 500 may continue at block 524.

At block 524, the fault analysis unit 310 may determine smear lengths for each layer and each fault displacement. For each shale layer, the fault analysis unit 310 may calculate smear length for continuous and discontinuous smears. For discontinuous smears, there may be a fixed part and a probabilistic part of the smear length. The probabilistic part of smear length may depend on a probabilistic value of the SSFc. Uncertainty of smear length may be associated with the uncertainty on SSF and SSFc (such as it may include one or more of the following parameters: layer thickness, displacement, ductility factor). The flow 500 may continue at block 526.

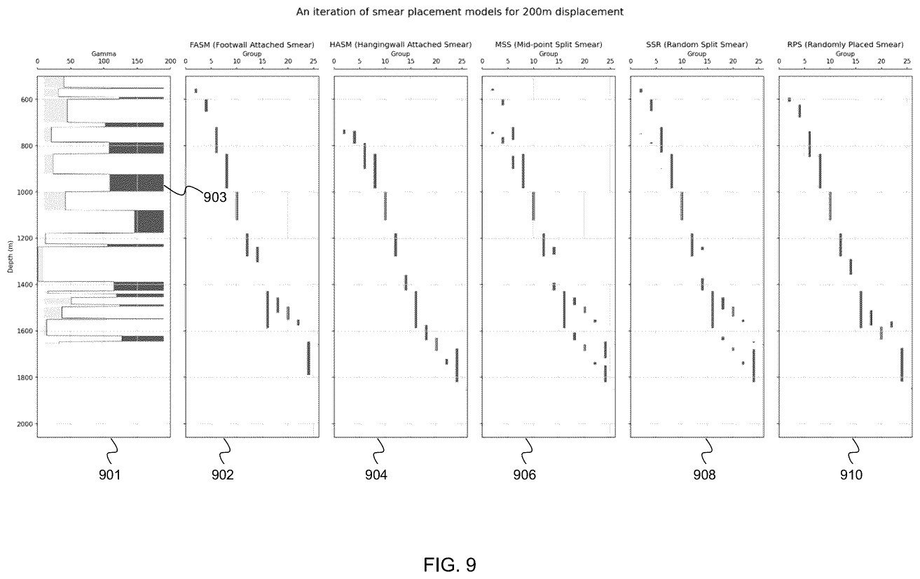

At block 526, the fault analysis unit 310 may combine smear lengths and placement methods to define smear position for each layer, placement method, and fault displacement. Smear lengths may be used in combination with placement operations to define the position of the smear for each layer, for each placement method, and for each increment of displacement along the fault plane. For some implementations, lateral continuity of smear and smear breaches along the fault may be ensured by including a lateral continuity parameter that is a function of displacement. FIG. 9 includes graphs showing smear placement for different placement methods for one given displacement. The graph 902 shows an example smear placement for FASM. The graph 904 shows an example smear placement for HASM. The graph 906 shows an example smear placement for MSS. The graph 908 shows an example smear placement for SSR. The graph 910 shows an example smear placement for RPS. In each placement method, the graph shows the position of individual smear segments obtained from smearing of the individual shale layers 903 defined from the gamma ray log 901 for one iteration of the model at one displacement (e.g., 200 m). Referring to FIG. 5, the flow 500 may continue at block 528.

At block 528, the fault analysis unit 310 may determine likelihood of smear presence at any given location along the fault based on the smear positioning. The likelihood of presence of smear and smear breach may be combined, where they may be weighted in a probabilistic manner or based on any other suitable weighting methodology. The weighting and relative likelihood may be based on geological empirical/field observations, geo-mechanical parameters related to elastic properties, a likelihood of rupture, and/or geo-mechanical simulations obtained from numerical or experimental simulations. The flow 500 may continue by looping back to block 506. For each iteration of the model a probabilistic likelihood of occurrence of smear and smear breaches along the fault plane may be obtained. The model may be run stochastically for a number of iterations as considered statistically appropriate and as required for the data and number parameters (such as the placement methods, presence of smear, smear breaches, and lateral continuity)

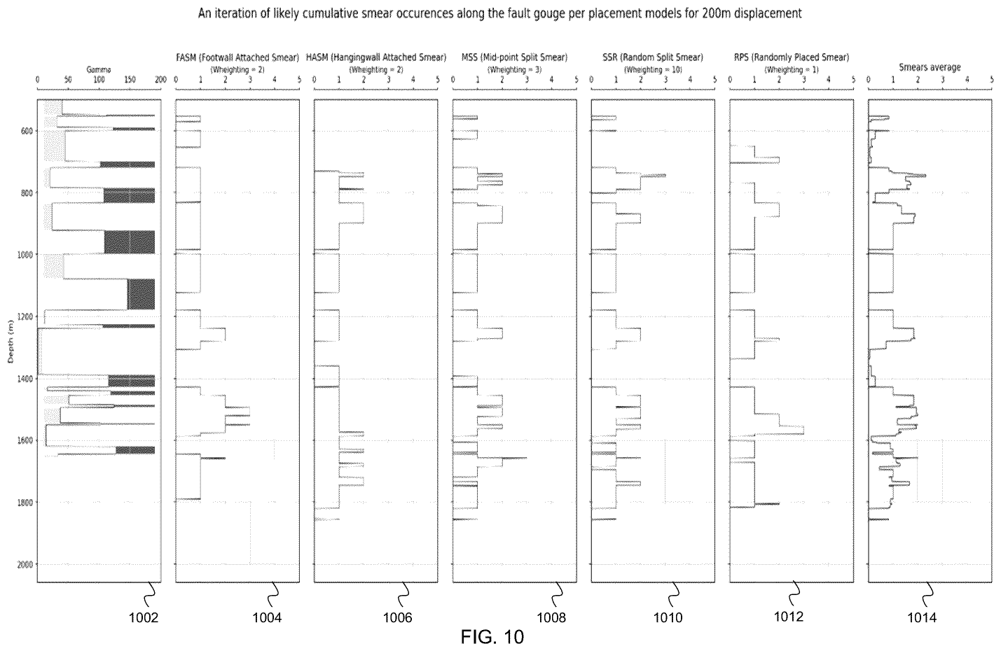

FIG. 10 includes graphs showing cumulative occurrence of smear for given locations along a fault gouge based on different placement models. The graphs 1004-1012 relate to different placement methods (such as FASM, HASM, MSS, SSR, and RPS) applied on a synthetic well for one given displacement of 200 m (throw in meters). The graph 1014 shows a weighted mean considering the different placement methods. The graph 1014 represents one iteration of a stochastic model for one given fault displacement (e.g., 200 m) for the purpose of illustration.

Referring back to FIG. 5, the flow 500 may continue to block 530. At block 530, the fault analysis unit 310 calculates stochastic likelihood of presence of smear along the fault gouge. The fault analysis unit 310 may run stochastic iterations to compute a probabilistic likelihood of presence of smear and smear breaches at any given position along the fault and for any given displacement. Such a process may run for a defined number of iterations as considered statistically appropriate and as required for the data and number parameters (such as the placement methods, presence of smear, smear breaches, and lateral continuity). The stochastic iterations of occurrence of smear and smear breaches along the fault plane may be integrated and analyzed to indicate likelihood of occurrence of smear at a given point along the fault. The flow 500 may continue at block 532.

At block 532, the fault analysis unit 310 may establish risk scenarios based on one or more statistical models. The fault analysis unit 310 may define risking thresholds and different scenarios considering the likelihood of occurrence of smear and smear breach to present different alternative scenarios associated with different levels of risk of smear and smear breach occurrences and associated fault sealing potential. Risk scenarios may be presented in the form of p-values scenarios 430 of the smear likelihood.

Some implementations of the fault analysis unit 310 may perform the operations at blocks 502-532 as described above. In these implementations, across-fault fluid flow may occur in absence of smear and where there is across-fault reservoir-to-reservoir juxtaposition. Across-fault barrier to flow (seal) may occur in presence of seal-to-seal or seal-to-reservoir or presence of smear may occur. Alternatively, other implementations of the fault analysis unit 310 (see block 534) may perform the above-noted operations in combination with a smear continuum method such as SGR in order to associate the SGR calculation with a parameter of risk associated to the occurrence of smear and smear breaches as defined herein. In implementations that combine with SGR (or other models), the fault permeability or sealing may involve comparing breakthrough pressures to fluid pressures related to shale gouge content and fluid viscosity. The flow 500 may continue at block 536.

At block 536, the fault analysis unit 310 may determine likely position of leak points and fluid column heights.

Some implementations may utilize juxtaposition to estimate across-fault sealing capacity. The fault analysis unit 310 may estimate across-fault sealing capacity by integrating the statistical occurrence of smear and smear breaches that have an associated risk threshold (as previously defined) with reservoir and seal horizon juxtaposition (block 538). The juxtaposition methodology may use an Allan map (i.e., representation on a fault plane of the layers' overlap on each side of a fault plane), a triangle diagram, or other suitable model to establish the layer's juxtaposition on each side of the fault plane.

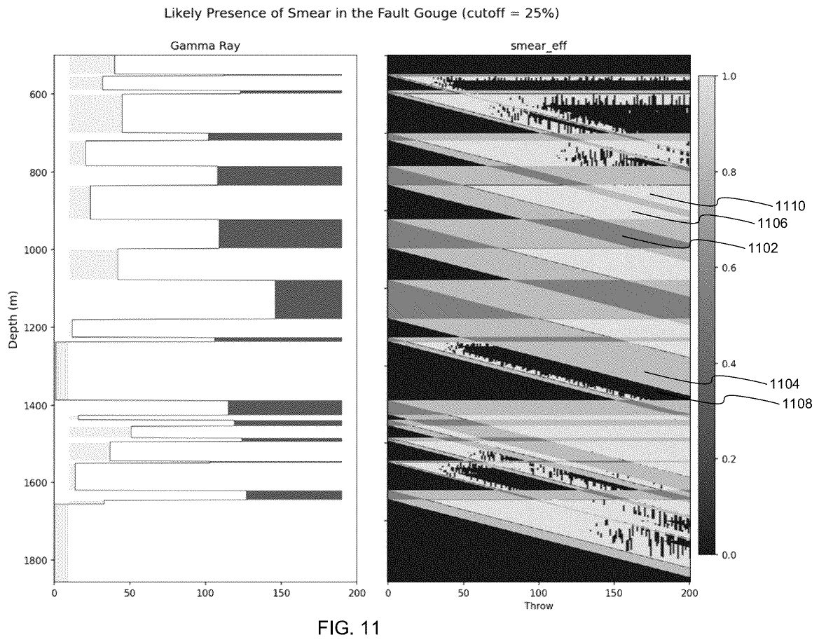

FIG. 11 includes a graph showing shale juxtaposition. In FIG. 11, shale juxtaposition (areas shown in shades 1102 and 1104) is combined with leak risk based on smear likelihood cut off of 25% (i.e., P75 if expressed in p-values). Area of the shade 1102 are shale-smear-shale or shale-breach-shale. Areas of the shade 1104 are sand-breach-shale or sand-smear-shale. Areas of shade 1110 are sand-smear-sand. Areas of the shade 1108 are sand-breach-sand. Areas in shade 1108 show where smear is likely to be absent along the fault gouge and reservoir-to-reservoir contact to occur. In the case of a reservoir-to-reservoir juxtaposition fluid flow (leak) may take place.

From block 536, the flow 500 continues to “A”. In FIG. 6, the flow may continue from “A” to one or more of blocks 602, 604, and 606. The fault analysis unit 310 may present results of the operations described herein in any suitable way. For example, the fault analysis unit 310 may present a probabilistic curve representing the likely occurrence of smear along a juxtaposed well affected by a given displacement. The fault analysis unit 310 may present a two-dimensional triangle diagram representing the likely presence of smear for a given risk threshold where the well lithology may be shown on a Y axis and the displacement on an x-axis (see FIG. 9). The fault analysis unit 310 may present an Allan map on a three-dimensional fault plane (that may be visualized on a projected 2D surface or as a 3D plane).

At block 602, the fault analysis unit 310 displays results on the fault in a three-dimensional diagram (or projected on a 2D surface domain) or projects the results to a map view along the fault length.

At block 604, the fault analysis unit 310 may integrate one or more intermediate or final results with a static model and a dynamic model to understand fluid flow. The fault analysis unit 310 also may simulate recovery based on the results of the operations described herein.

At block 606, the fault analysis unit 310 may calculate fluid/gas containment or volume capacity of an area of a subsurface reservoir rock interval.

From any one of blocks 602, 604, and 606, the flow may continue at block 608. At block 608, a subsurface operation may be performed based on any of the intermediate or final results described herein. Subsurface operations may include operations for hydrocarbon recovery such as drilling, artificial lift, well stimulation, hydraulic fracturing, etc. Additionally, various decisions may be made based on one or more intermediate or final results described herein because they may identify geological risks, where such decisions may be to acquire more data or apply different methods or techniques to drilling, exploration, production, abandon a well, creation of an injection well, etc. The decisions and/or operations also may relate to oil, gas, carbon, and other fluid storage, mineral exploration, mine water drainage, geothermal, hydrogeology, and waste containment (such as radioactive containment). Additionally, business decisions may be made based on one or more intermediate or final results described herein.

FIG. 12 is a block diagram illustrating a computer system that may be utilized with some implementations. In FIG. 12, a computer system 1200 may include one or more processors 1202 connected to a system bus 1204. The system bus 1204 may be connected to memory 1208 and a network interface 1205. The memory 1208 may include any suitable memory random access memory (RAM), non-volatile memory (e.g., magnetic memory device), and/or any device for storing information and instructions executable by the processor(s) 1202. The network interface 105 may provide connectivity to any suitable network, such as a wired network, wireless network, satellite network, etc.

The computer system 1200 may include additional peripheral devices. For example, the computer system 1200 may include multiple external multiple processors. In some implementations, any of the components can be integrated or subdivided.

The computer system 1200 also may include a fault analysis unit 310. The fault analysis unit 310 may implement the methods and operations described herein. For example, the fault analysis unit 310 may perform the operations described with reference to FIGS. 3, 5, and 6.

Any component of the computer system 1200 can be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

### Additional Aspects and Implementations

In some instances, a critical aspect of predicting the impact of smear is the highly stochastic nature of the process of smear generation and brittle faulting in general. Yet many approaches have at their heart an assumption of plasticity (SSF, SGR, CSP, Smear Potential). Whereas others, for example models of shale smear localization, acknowledge the brittle-processes and the random nature of faulting but make simplifying assumptions such as that a smear will be continuous, and any breaks are limited in number, for example FASM, HASM, MSS, SSR, RPS, etc. Further, most of these approaches treat the generation of smear as a 1D process, only considering isolated columns of a fault for a given throw. A further challenge is that systematic observations of shale smear are limited, such that understanding of the controlling factors may be poor, yet many factors have been attributed as having a fundamental control on resulting smear including: 1) Rock properties, for example: permeability; clay ductility—a ductile shale will smear further along a fault (higher SSFc), etc. 2) Volume of clay in the fault zones derived from a layer, many models inherently assume a constant volume of clay in the fault zone that is progressively smeared along a fault as throw increases (e.g. SGR). Whereas some observations suggest that the volume of clay available for smear can increase with throw due to continual abrasion of clay-rich layers, and/or the process of cataclasis; and 3) Fault splays and the complexities in the fault zone. In many cases, the geometry of the fault zone can be important. For example, smear can be generated in anastomosing fault zones, without ductile smearing of the clay.

Given the inherent uncertainties in all of the above, an approach to assessing the sealing properties of faults should be able to include such ambiguities. Furthermore, both the properties of any clay smear and its likelihood of presence should be considered. Some implementations include a generic method whereby the seal properties of a fault can be simulated in a probabilistic manner. Some implementations take the RSS model as an underlying model, to help demonstrate this approach and consider smear from a single shale bed. In the RSS model, the length of smear is set to a maximum length controlled by the SSFc. The permeability of the smear may be calculated based on the strain assumed by the smear, such that:

$$κ = \{ \begin{matrix}\frac{{κ}_{0} Δ z}{Δ z + t} & where t < ( {SSF}_{c} - 1 ) Δ z \\ \frac{κ}{{SSF}_{c}} & where t \geq ( {SSF}_{c} - 1 ) Δ z\end{matrix}$$

with κ the permeability, t the thickness of the layer and Δz the displacement along the fault plane
In addition, the presence of smear could be modelled based on the Random Split Smear method, where a gap of length (g):

$$g = t - ( {SSF}_{c} - 1 ) Δ z$$

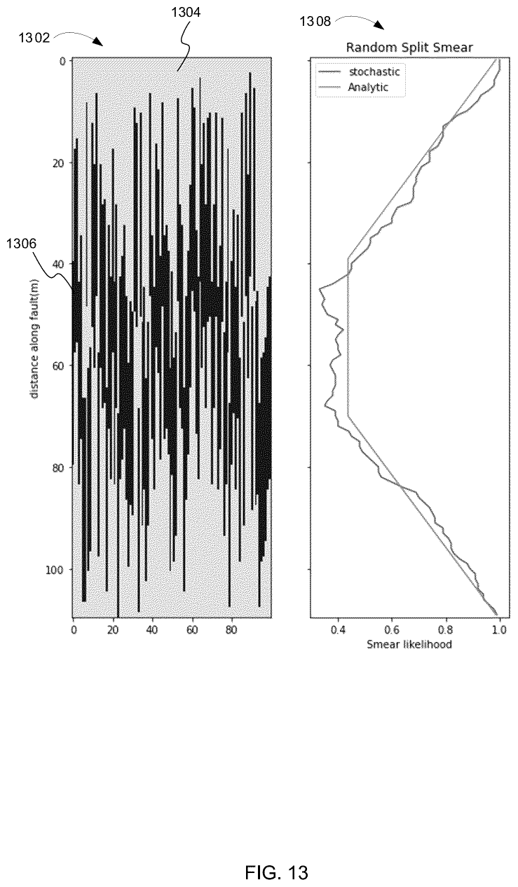

Can be placed at any point between the top of the uppermost shale bed, and the base of the lowermost shale bed, as defined by a known distribution (e.g., uniform, gaussian, etc.). Given such a model the likelihood that smear exists at any point and the properties of that smear can be assessed. For relatively simple cases, e.g., constant SSF_{c} and κ₀ this likelihood and properties could be determined analytically (e.g., FIG. 13).

FIG. 13 includes graphs showing results of 100 simulations using the Random Split Smear placement method for one given displacement (e.g., here, 100 m). In the graph 1302, smear is indicated with the shading 1304 and gap is indicated with shading 1306. The graphs 1302 and 1308 relate to a single 10-meter-thick shale bed having a fault throw=100 m and SSFc=7. The graph 1308 shows the resulting likelihood of Smear presence for the 100 realizations based on an analytic calculation.

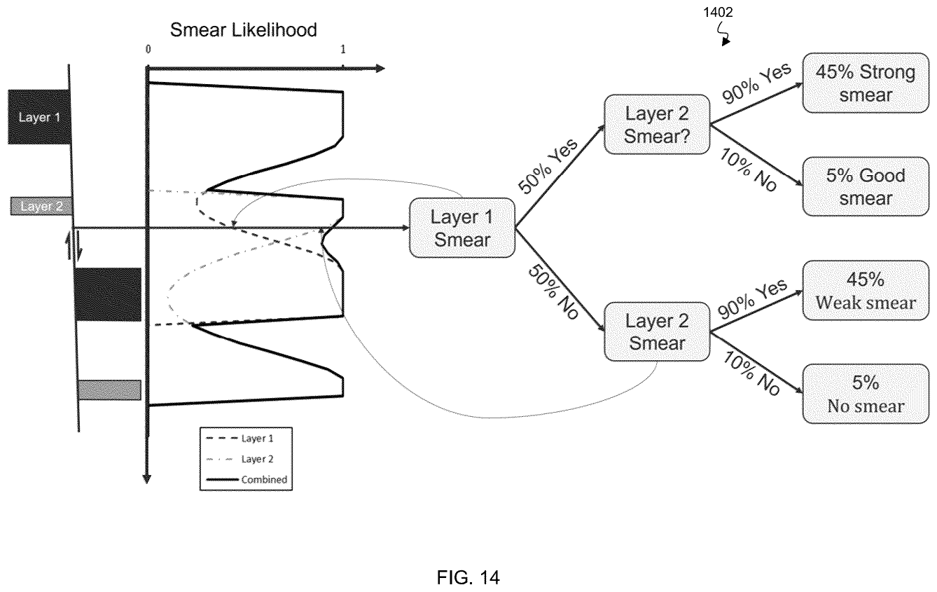

However, for more complex scenarios, for example uncertain SSFc and κ₀ multiple shale beds, non-uniform deformation of smear, etc., determining these properties based on the entire succession can lead to complex conditional relationships, so it may be more pragmatic to run stochastic simulations. FIG. 14 includes a diagram illustrating the complexity of determining smear likelihood and properties at one point on a fault for a two-layer case. The graph 1402 indicates the possible distribution of properties, given the properties of smear generated by a particular layer are likely to be uncertain. Given the likelihood of occurrence and the properties of any smear, inferred as a function of throw, and stratigraphic position, the next step in an analysis may be to map these functions onto a fault surface. Once the statistical likelihood and properties of smear have been defined on the fault plane, some implementations may geostatistically simulate the presence of smear (e.g., applying truncated gaussian simulations) and its properties (e.g., using sequential gaussian simulations). The simulated fault properties (or ensemble of simulations) can then be used for further analysis, for example to determine likely hydrocarbon column height, for flow simulations, etc.

FIGS. 1-14 and the operations described herein are examples meant to aid in understanding example implementations and should not be used to limit the potential implementations or limit the scope of the claims. None of the implementations described herein may be performed exclusively in the human mind nor exclusively using pencil and paper. None of the implementations described herein may be performed without computerized components such as those described herein. For example, this description may refer to one or more models, where the models may include data produced or derived via operations, components, and/or functionality described herein. Therefore, the models do not refer to any data derived exclusively in the human mind or exclusively with pencil and paper.

Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, e.g., one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Clauses

Some implementations may include the following clauses.

Clause 1: A method for detecting leaks across a geological fault, the method comprising: determining probabilities of smears and smear breaches along a fault plane of the geological fault; and determining, based on the probabilities, one or more leak points through which hydrocarbon fluid leaks from a subsurface reservoir.

Clause 2: The method of clause 1 further comprising: performing a subsurface operation based on position of the leak points.

Clause 3: The method of any one or more of clauses 1-2 further comprising: determining, based on the probabilities, a probability distribution for column height for one or more fluids in the subsurface formation. The method of claim 1 further comprising: determining probabilities of juxtaposition of shale layers around the subsurface reservoir, wherein the determination of the leak points is further based on the probabilities of juxtaposition of shale layers.

Clause 4: The method of any one or more of clauses 1-3 further comprising: selecting a smear placement methodology from a plurality of smear placement methodologies; and determining the probabilities of smears and smear breaches based on the selected smear placement methodology.

Clause 5: The method of any one or more of clauses 1-4: assigning a respective ductility factor to each shale layer, wherein the probability of smear breach for each smear is based, at least in part, on the respective ductility factor of the shale layer.

Clause 6: The method of any one or more of clauses 1-5 further comprising: identifying locations of sand volumes and shale volumes based on determining probabilities and uncertainties in lithologies (506) from geological proxies such as well log curves, wherein the probabilities of smears and smear breaches are based, at least in part, upon the locations of sand volumes and shale volumes.

Clause 7: The method of any one or more of clauses 1-6 further comprising: determining length of each respective smear along the fault plane based on a critical smear factor and/or a shale smear factor associated with the respective shale layer.

Clause 8: The method of any one or more of clauses 1-7 further comprising: determining spatially the lateral continuity of breaches (522), based on geological or geomechanical rules, where the lateral continuity of smear and smear breaches are based, at least in part on the lateral continuity parameter.

Clause 9: The method of any one or more of clauses 1-8 further comprising: determining spatially the lateral continuity of breaches (522), based on geological or geomechanical rules, where the lateral continuity of smear and smear breaches are based, at least in part on the lateral continuity parameter.

Clause 10: The method of any one or more of clauses 1-9 further comprising:
determining risk scenarios p-values (534), based on probability distribution of smears, smear breaches and leak points.

Clause 11: The method of any one or more of clauses 1-10 further comprising: presenting a spatial representation of the geological fault, the smears, and the leak points on a display device.

Clause 12: One or more machine-readable mediums including computer-executable instructions for detecting leaks across a geological fault, the instructions comprising: instruction to determine probabilities of smears and smear breaches along a fault plane of the geological fault; and instructions to determine, based on the probabilities, one or more leak points through which hydrocarbon fluid leaks from a subsurface reservoir.

Clause 13: The one or more machine-readable mediums of clause 12, further comprising: instructions to perform a subsurface operation based on the leak points.

Clause 14: The one or more machine-readable mediums of any one or more of clauses 12-13, further comprising: instructions to determining, based on the probabilities, a column height for one or more fluids in the subsurface formation.

Clause 15: The one or more machine-readable mediums of any one or more of clauses 12-14, further comprising: instructions to determine probabilities of juxtaposition of shale layers around the subsurface reservoir, wherein the determination of the leak points is further based on the probabilities of juxtaposition of shale layers.

Clause 16: The one or more machine-readable mediums of any one or more of clauses 12-15 further comprising: instructions to select a smear placement methodology from a plurality of smear placement methodologies; and determining the probabilities of smears and smear breaches based on the selected smear placement methodology.

Clause 17: The one or more machine-readable mediums of any one or more of clauses 12-16 further comprising: instructions to assign a respective ductility factor to each smear, wherein the probability of smear breach for each smear is based, at least in part, on the respective ductility factor of the smear.

Clause 18: The one or more machine-readable mediums of any one or more of clauses 12-17 further comprising: instructions to identify locations of sand volumes and shale volumes based on Gamma Ray signal data, wherein the probabilities of smears and smear breaches are based, at least in part, upon the locations of sand volumes and shale volumes.

Clause 19: An apparatus comprising: a processor; and one or more computer-readable mediums including instructions which are executable via the one or more processors, the instructions for detecting leaks across a geological fault, the instructions including instructions to determine probabilities of smears and smear breaches along a fault plane of the geological fault; and instructions to determine, based on the probabilities, one or more leak points through which hydrocarbon fluid leaks from a subsurface reservoir.

Clause 20: The apparatus of clause 19 further comprising: instructions to perform a subsurface operation based on the leak points.

Clause 21: The apparatus of any one or more of clauses 15-18 further comprising: instructions to determine, based on the probabilities, a column height for one or more fluids in the subsurface formation.

Clause 22: The apparatus of any one or more of clauses 15-19 further comprising: determining probabilities of juxtaposition of shale layers around the subsurface reservoir, wherein the determination of the leak points is further based on the probabilities of juxtaposition of shale layers.

What is claimed is:

1. A method for detecting leaks across a geological fault, the method comprising:
determining probabilities of smears and smear breaches along a fault plane of the geological fault; and
determining, based on the probabilities, one or more leak points through which hydrocarbon fluid leaks from a subsurface reservoir.

2. The method of claim 1 further comprising:
performing a subsurface operation based on position of the leak points.

3. The method of claim 1 further comprising:
determining, based on the probabilities, a probability distribution for column height for one or more fluids in the subsurface formation.

4. The method of claim 1 further comprising:
determining probabilities of juxtaposition of shale layers around the subsurface reservoir, wherein the determination of the leak points is further based on the probabilities of juxtaposition of shale layers.

5. The method of claim 1 further comprising:
selecting a smear placement methodology from a plurality of smear placement methodologies; and
determining the probabilities of smears and smear breaches based on the selected smear placement methodology.

6. The method of claim 5 further comprising:
assigning a respective ductility factor to each shale layer, wherein the probability of smear breach for each smear is based, at least in part, on the respective ductility factor of the shale layer.

7. The method of claim 1 further comprising:
identifying locations of sand volumes and shale volumes based on determining probabilities and uncertainties in lithologies (506) from geological proxies such as well log curves, wherein the probabilities of smears and smear breaches are based, at least in part, upon the locations of sand volumes and shale volumes.

8. The method of claim 1 further comprising:
determining length of each respective smear along the fault plane based on a critical smear factor and/or a shale smear factor associated with the respective shale layer.

9. The method of claim 1 further comprising:
determining spatially the lateral continuity of breaches (522), based on geological or geomechanical rules, where the lateral continuity of smear and smear breaches are based, at least in part on a lateral continuity parameter.

10. The method of claim 1 further comprising:
using the probabilities to generate one or more geostatistical realizations of smear properties and/or smear breaches on the fault plane.

11. The method of claim 1 further comprising:
determining risk scenarios p-values (534), based on probability distribution of smears, smear breaches and leak points.

12. The method of claim 1 further comprising:
presenting a three-dimensional representation of the geological fault, the smears, and the leak points on a display device.

13. One or more computer-readable mediums including computer-executable instructions for detecting leaks across a geological fault, the instructions comprising:
instructions to determine probabilities of smears and smear breaches along a fault plane of the geological fault; and
instructions to determine, based on the probabilities, one or more leak points through which hydrocarbon fluid leaks from a subsurface reservoir.

14. The one or more computer-readable mediums of claim 13, the instructions further comprising:
instructions to perform a subsurface operation based on position of the leak points.

15. The one or more computer-readable mediums of claim 13, the instructions further comprising:
instructions to determining, based on the probabilities, a probability distribution of column height for one or more fluids in the subsurface formation.

16. The one or more computer-readable mediums of claim 13, the instructions further comprising:
instructions to determine probabilities of juxtaposition of shale layers around the subsurface reservoir, wherein the determination of the leak points is further based on the probabilities of juxtaposition of shale layers.

17. The one or more computer-readable mediums of claim 13, the instructions further comprising:
instructions to select a smear placement methodology from a plurality of smear placement methodologies; and
determining the probabilities of smears and smear breaches based on the selected smear placement methodology.

18. The one or more computer-readable mediums of claim 13, the instructions further comprising:
instructions to assign a respective ductility factor to each shale layer, wherein the probability of smear breach for each smear is based, at least in part, on the respective ductility factor of the shale layer.

19. The one or more computer-readable mediums of claim 13, the instructions further comprising:
instructions to identify locations of sand volumes and shale volumes based on Gamma Ray signal data, wherein the probabilities of smears and smear breaches are based, at least in part, upon the locations of sand volumes and shale volumes.

20. A system comprising:
a processor; and
one or more computer-readable mediums including instructions which are executable via the one or more processors, the instructions for detecting leaks across a geological fault, the instructions including
instructions to determine probabilities of smears and smear breaches along a fault plane of the geological fault; and
instructions to determine, based on the probabilities, one or more leak points through which hydrocarbon fluid leaks from a subsurface reservoir.

21. The system of claim 20, the instructions further comprising:
instructions to perform a subsurface operation based on position of the leak points.

22. The system of claim 20, the instructions further comprising:
instructions to determine, based on the probabilities, a probability distribution of column height for one or more fluids in the subsurface formation.

23. The system of claim 20, the instructions further comprising:
determining probabilities of juxtaposition of shale layers around the subsurface reservoir, wherein the determination of the leak points is further based on the probabilities of juxtaposition of shale layers.
